(19) United States
(12) Patent Application Publication
(10) Pub. No.: US 2019/0235214 A1
(43) Pub. Date: Aug. 1, 2019

(54) SPHERICAL CAMERA LENS SYSTEM, CAMERA SYSTEM AND LENS ASSEMBLY

(71) Applicant: ZERO PARALLAX TECHNOLOGIES AB, Åre (SE)

(72) Inventors: Vygantas KIREJEVAS, Tallinn (EE); Edmundas BALCIUNAS, Vilnius (LT)

(73) Assignee: Zero Parallax Technologies AB, Åre (SE)

(21) Appl. No.: 16/315,841

(22) PCT Filed: Jul. 5, 2016
(86) PCT No.: PCT/EP2016/065788

§ 371 Date: Jan. 7, 2019

(51) Int. Cl. G02B 13/06; G03B 37/00; H04N 5/225; H04N 5/232

(52) U.S. Cl. CPC G02B 13/06; G03B 37/00; H04N 5/23238; H04N 5/2254; H04N 5/2253

(57) ABSTRACT

A lens assembly for a camera, a camera lens system, and a camera system. The lens assembly has an optical path from an object side to an image side, the lens assembly comprising a first lens group having a first optical axis and comprising a first primary lens; an aperture stop; and a light redirecting member, wherein the light redirecting member is arranged between the first lens group and the aperture stop such that the optical path comprises a first optical path segment and a second optical path segment, wherein the first optical path segment and the second optical path segment form an angle larger than 30 degrees, and the lens assembly having a horizontal field of view in the range from 5 degrees to 135 degrees.

### FIELD

The present disclosure relates to the fields of optics and image capturing. In particular, the present disclosure relates to a lens assembly and camera lens system, such as for capturing a spherical, semi-spherical or at least partly spherical field of view. In particular, the present disclosure relates to panoramic and/or spherical still and moving image capture and a camera system.

### BACKGROUND

In panoramic photography it is important to establish the no-parallax point (NPP) on the lens system. While capturing a panoramic image with standard camera it is desired that the camera is rotated around the axis going through that point. This is desired in order to avoid the artefacts appearing on the stitched output image due to angular displacement error (parallax).

Parallax is a displacement or difference in the apparent position of an object (in respect to object positioned at a different distance) viewed along two different lines of sight.

While there are rather simple solutions to avoid parallax in panoramic photography by moving the camera back and forward on an axis of rotation until the angular error is diminished, the problem persists when it comes to a motion picture capture as the lens systems have to be placed next to each other.

Current solutions require heavy use of post-processing by use of stitching algorithms, and present devices are not able to provide a satisfactory result, in particular when it comes to panoramic movies with multiple objects of interest at different distances from the camera.

U.S. Pat. No. 7,298,392 entitled “Omni-directional camera design for video conferencing” discloses a system using cameras that are pointed inwards and capture the scene through a reflective surface. An N-sided reflective surface reflects its surroundings in 360 degrees, where N cameras each associated with a different side of said N-sided reflective surface are aligned to have a small non-zero distance between entrance pupil (non-parallax point) of projection relative to each other.

WO 2012/0136388 entitled “Capturing Panoramic or Semi-Panoramic 3d Scenes” describes a solution that uses a number of cameras and reflective surfaces arranged in a way that enables to capture a panoramic image, as well as a stereoscopic (3D) panoramic image.

### SUMMARY

There is a need for apparatus and methods for provision of panoramic imaging with reduced parallax artefacts.

Accordingly, a lens assembly for a camera is provided, the lens assembly having an optical path from an object side to an image side, the lens assembly comprising a first lens group having a first optical axis and comprising a first primary lens; an aperture stop; and optionally a light redirecting member. The light redirecting member, if present, is arranged between the first lens group and the aperture stop such that the optical path comprises a first optical path segment and a second optical path segment. The first optical path segment and the second optical path segment form an angle, e.g. larger than 30 degrees. The lens assembly may have a horizontal field of view less than 160 degrees such as less than 135 degrees, such as in the range from 5 degrees to 135 degrees.

Further, a camera lens system is provided, the camera lens system comprising a first lens assembly and optionally a second lens assembly, wherein the first lens assembly is a lens assembly as described herein and having a first entrance pupil with a first virtual position along the first optical axis, and the second lens assembly is a lens assembly as described herein and having a second entrance pupil with a second virtual position along the first optical axis of the second lens assembly. The first lens assembly and the second lens assembly may be arranged such that a distance between the first virtual position and the second virtual position is less than 10 mm. Preferably, the distance between the first virtual position and the second virtual position is less than 7 mm such as less than 3 mm.

The present lens assembly and camera lens system enable capture of panoramic spherical or at least semi-spherical moving pictures with reduced or no parallax error. Thus, the need for time-consuming post-processing (stitching and/or interpolation) is heavily reduced.

Also disclosed is a camera system comprising a camera lens system as described herein. Further, the camera system comprises one or more image detectors having a first detector area and a second detector area, wherein a first image plane of the first lens assembly is recorded by the first detector area and a second image plane of the second lens assembly is recorded by the second detector area.

It is an important advantage of the present disclosure that a camera with high pixel angular density is provided.

### BRIEF DESCRIPTION OF THE DRAWINGS

Embodiments of the invention will be described in more detail in the following with regard to the accompanying figures. The figures show one way of implementing the present invention and are not to be construed as being limiting to other possible embodiments falling within the scope of the attached claim set.

FIG. 1 shows an exemplary lens assembly according to the invention,

FIG. 2 shows a cross-section of the lens assembly in FIG. 1.

FIG. 3 shows a top view of a part of a camera lens system,

FIG. 4 shows a perspective view of a part of a camera lens system,

FIG. 5 shows an exemplary fifth lens assembly of a camera lens system,

FIG. 6 shows a side view of a first primary lens, and

FIG. 7 shows a perspective cut-away view of an exemplary camera system.

### DETAILED DESCRIPTION

The lens assembly comprises one or more lens groups, each lens group comprising one or more lenses. A lens group has an optical axis. A lens has a first surface and a second surface with a thickness at the center of the lens, the thickness being the distance along the principal axis between the first and second surface. The first surface is the light receiving surface and the second surface is the light departing surface. In other words, the first surface of a lens faces the object side and the second surface of a lens faces the image side. A distance between two lenses is the distance between a second surface of a lens and a first surface of a neighbouring lens along the optical axis.

The lens assembly comprises a first lens group. The first lens group may comprise one or more, such as a plurality of first lenses.

The first lens group comprises a first primary lens. The first surface of the first primary lens may be convex or plane. The second surface of the first primary lens may be concave or plane. The first surface of the first primary lens and/or the second surface of the first primary lens may be spherical. The first surface radius r_{1.1.1} (curvature) of the first primary lens may be in the range from 1 mm to 500 mm, such as in the range from 10 mm to 100 mm. The first surface radius r_{1.1.1} (curvature) of the first primary lens may be in the range from 30 mm to 70 mm, such as in the range from 40 mm to 60 mm. In one or more exemplary lens assemblies, the first surface radius r_{1.1.1} of the first primary lens is 50 mm. The second surface radius r_{1.1.2} (curvature) of the first primary lens may be in the range from 2 mm to 600 mm, such as in the range from 10 mm to 200 mm. The second surface radius r_{1.1.2} (curvature) of the first primary lens may be in the range from 50 mm to 100 mm, such as in the range from 65 mm to 85 mm. In one or more exemplary lens assemblies, the second surface radius r_{1,1,2} (curvature) of the first primary lens is 73.82 mm.

In one or more exemplary lens assemblies, r_{1,1,1} is larger than or less than r_{1,1,2}. In one or more exemplary lens assemblies, r_{1,1,2} is in the range from 1.1*r_{1,1,1} to 10*r_{1,1,1}.

In one or more exemplary lens assemblies, r_{1,1,2} is in the range from 1.2*r_{1,1,1} to 2*r_{1,1,1}.

A lens surface may be defined by the conic constant K and the radius of curvature r.

The first surface of the first primary lens and/or the second surface of the first primary lens may be aspheric, such as parabolic or hyperbolic or a prolate spheroid. An aspheric lens may reduce the number of lens elements, in turn enabling a more compact camera lens system/camera system with fewer parts.

The first surface of the first primary lens may be a hyperbolic surface with a conic constant K_{1,1,1}<−1. One or more exemplary first surfaces of the first primary lens may have a conic constant K_{1,1,1} in the range from −20 to −5, such as in the range from −8 to −12. One or more exemplary first surfaces of the first primary lens may be hyperbolic and having a radius of curvature r_{1,1,1} in the range from 20 mm to 200 mm. In one or more exemplary lens assemblies, K_{1,1,1}=−1 (parabolic). The first surface of the first primary lens may be a hyperbolic surface with K_{1,1,1}−−10 and r_{1,1,1}=32 mm.

The second surface of the first primary lens may be a prolate spheroid (prolate elliptical) with a conic constant 0>K_{1,1,2}>−1. One or more exemplary second surfaces of the first secondary lens may have a conic constant K_{1,1,2}>−1 in the range from −0.9 to −0.5. In one or more exemplary lens assemblies, K_{1,1,2}=−1 or K_{1,1,2}=0 or K_{1,1,2}<−1. One or more exemplary second surfaces of the first primary lens may be a prolate spheroid and having a radius of curvature r_{1,1,2} in the range from 2 mm to 20 mm. The second surface of the first primary lens may be a prolate spheroid with K_{1,1,2}=−0.7 and r_{1,1,2}=6.87 mm.

The first primary lens may comprise one or more side surfaces. A side surface may be plane. The first primary lens may comprise a first side surface S_{i,1} having a first side normal N_{i,1,} and a second side surface S_{i,2} having a second side normal N_{i,2}. The first primary lens may comprise a third side surface S_{i,3} having a third side normal N_{i,3}, and/or a fourth side surface S_{i,4} having a fourth side normal N_{i,4}, where i is an index of the I'th lens assembly. A first angle between the first side normal and the first optical axis may be in the range from 10 degrees to 90 degrees. A second angle between the second side normal and the first optical axis may be in the range from 10 degrees to 90 degrees. A third angle between the third side normal and the first optical axis may be in the range from 10 degrees to 90 degrees. A fourth angle between the fourth side normal and the first optical axis may be in the range from 10 degrees to 90 degrees. A first primary lens with side surface(s) allows for a more compact camera design. Further, side surfaces in first primary lenses enable a further reduction in the distance between entrance pupils of the lens assemblies. In one or more exemplary lens assemblies, the first angle is 45 degrees or in the range from 20 degrees to 45 degrees. In one or more exemplary lens assemblies, the second angle is 45 degrees or in the range from 20 degrees to 45 degrees. In one or more exemplary lens assemblies, the third angle is 45 degrees or in the range from 20 degrees to 45 degrees. In one or more exemplary lens assemblies, the fourth angle is 45 degrees or in the range from 20 degrees to 45 degrees.

A side surface, such as the first side surface and/or the second side surface, of the first primary lens may be coated with a coating. The third side surface and/or the fourth side surface of the first primary lens may be coated with a coating. The coating may be non-reflective or substantially non-reflective, e.g. by reflecting less than 5% of incoming light. The coating may be non-transmissive or substantially non-transmissive, e.g. by transmitting less than 5% of incoming light. The coating may be an absorbing coating, e.g. comprising titanium nitride and/or niobium nitride. Coated side surfaces reduce or prevent internal reflections and/or reduce or prevent cross-over of light from one lens assembly to another.

The first primary lens may have a thickness in the range from about 1 mm to 50 mm, such as in the range from 10 mm to about 30 mm. The thickness t_{1,1} of the first primary lens may be in the range from 20 mm to 22 mm, such as about 21.2 mm.

The first primary lens may be made of a material having a refractive index in the range from 1.4 to 2.0, such as in the range from 1.55 to 1.65. A higher refractive index, e.g. up to 5, may be employed, e.g. for non-visible applications.

The lens assembly comprises an aperture stop. The aperture stop has an aperture with desired size and shape. The aperture may be squared or rectangular, e.g. with rounded corners. The aperture may be circular, oval or other suitable shape.

The lens assembly comprises a light redirecting member. The light redirecting member may be or comprise a mirror or a prism. The light redirecting member may comprise a first reflecting surface. The first reflecting surface may be plane. In one or more exemplary lens assemblies, the first reflecting surface is plane and having a normal, wherein the angle between the normal and the first optical axis is in the range from 15 degrees to 75 degrees, such as in the range from 40 degrees to 50 degrees, preferably 45 degrees. The first reflecting surface may be a trapezoid. A trapezoid-shaped first reflecting surface enables a compact camera lens system, in particular for a camera system with 5 lens assemblies. The first reflecting surface may be curved. The first reflecting surface may have an area in the range from 1 mm² to 1.500 mm, such as in the range from 50 to 150 mm².

The light redirecting member redirects the optical path to form an angle between two optical path segments. Thus, the entrance pupil of the lens assembly has a virtual position along the first optical axis of the first lens group. The light redirecting member of the lens assembly enables use of a plurality of lens assemblies with overlapping or coinciding entrance pupils.

The first lens group may comprise a first secondary lens. The first secondary lens may be arranged between the first primary lens and the light redirecting member. The first surface of the first secondary lens may be convex. The first surface of the first secondary lens may be concave or plane. The second surface of the first secondary lens may be concave. The second surface of the first secondary lens may be convex or plane. The first surface of the first secondary lens and/or the second surface of the first secondary lens may be spherical. The first surface radius r_{1,2,1} (curvature) of the first secondary lens may be in the range from 20 mm to 50 mm. The second surface radius r_{1,2,2} (curvature) of the first secondary lens may be in the range from 5 mm to 15 mm. In one or more exemplary lens assemblies, r_{1,2,1} is larger than or less than r_{1,2,2}.

The distance D_{1,1} between the first primary lens and the first secondary lens may be in the range from 10 mm to 30 mm, such as in the range from 18 mm to 22 mm. In one or more exemplary lens assemblies, the distance D_{1,1} is about 19.3 mm.

The first surface of the first secondary lens and/or the second surface of the first secondary lens may be aspheric, such as parabolic or hyperbolic or a prolate spheroid. An aspheric lens may reduce the number of lens elements, in turn enabling a more compact camera lens system/camera system with fewer parts.

The first surface of the first secondary lens may be a hyperbolic surface with a conic constant K_{1,2,1}<−1. One or more exemplary first surfaces of the first secondary lens may have a conic constant K_{1,2,1} in the range from −20 to −5, such as in the range from −8 to −12. One or more exemplary first surfaces of the first secondary lens may be hyperbolic and having a radius of curvature r_{1,2,1} in the range from 20 mm to 50 mm, such as from 30 mm to 35 mm. In one or more exemplary lens assemblies, K_{1,2,1}=−1 or K_{1,2,1}=0. The first surface of the first secondary lens may be a hyperbolic surface with K_{1,2,1}=−10 and r_{1,2,1}=32 mm.

The second surface of the first secondary lens may be a prolate spheroid (prolate elliptical) with a conic constant 0>K_{1,2,2}>−1. One or more exemplary second surfaces of the first secondary lens may have a conic constant K_{1,2,2} in the range from −0.9 to −0.5. In one or more exemplary lens assemblies, K_{1,2,2}=−1 or K_{1,2,2}=0 or K_{1,2,2}<−1. One or more exemplary second surfaces of the first secondary lens may be a prolate spheroid and having a radius of curvature r_{1,2,2} in the range from 2 mm to 20 mm, such as in the range from 5 mm to 15 mm. The second surface of the first secondary lens may be a prolate spheroid with K_{1,2,2}=−0.7 and r_{1,2,2}=6.87 mm.

The first primary lens may have a thickness in the range from about 10 mm to about 30 mm. The thickness t_{1,1} of the first primary lens may be in the range from 20 mm to 22 mm, such as about 21.2 mm.

The first secondary lens may have a thickness in the range from about 1 mm to about 10 mm. The thickness t_{1,2} of the first secondary lens may be in the range from 2 mm to 5 mm. such as about 3 mm.

The first secondary lens may be made of a material having a refractive index in the range from 1.4 to 2.0, such as in the range from 1.6 to 1.7.

The lens assembly may comprise a second lens group. The second lens group comprises a second primary lens and/or a second secondary lens. The aperture stop may be arranged between the light redirecting member and the second primary lens. In one or more exemplary lens assemblies, the second lens group comprises a second tertiary lens and/or a second quaternary lens.

The first surface of the second primary lens may be concave. The second surface of the second primary lens may be convex. The first surface of the second primary lens and/or the second surface of the second primary lens may be aspheric, such as parabolic or hyperbolic or a prolate spheroid. The first surface of the first primary lens and/or the second surface of the first primary lens may be spherical.

The second primary lens may have a thickness in the range from about 0.5 mm to about 10 mm. The thickness t_{2,1} of the second primary lens may be in the range from 1 mm to 3 mm, such as about 1.3 mm.

The second primary lens may be made of a material having a refractive index in the range from 1.4 to 2.0, such as in the range from 1.55 to 1.65. The second secondary lens may be made of a material having a refractive index in the range from 1.4 to 2.0, such as in the range from 1.55 to 1.65.

The second secondary lens may be arranged after the second primary lens. The first surface and the second surface of the second secondary lens may be convex. The second surface of the second secondary lens may be concave. The first surface of the second secondary lens and/or the second surface of the second secondary lens may be spherical. The first surface radius r_{2,2,1} of the second secondary lens may be in the range from 10 mm to 40 mm, such as in the range from 20 mm to 30 mm. In one or more exemplary lens assemblies, the first surface radius r_{2,2,1} of the second secondary lens is 24 mm. The second surface radius r_{2,2,2} of the second secondary lens may be in the range from −60 mm to −20 mm, such as in the range from −50 mm to −70 mm. In one or more exemplary lens assemblies, the second surface radius r_{2,2,2} of the second secondary lens is −42 mm. In one or more exemplary lens assemblies, |r_{2,2,1}| is less than |r_{2,2,2}|. In one or more exemplary lens assemblies, |r_{2,2,2}| is in the range from 1.2*r_{2,2,1} to 2.2*r_{2,2,1}.

The distance D_{2,1} between the second primary lens and the second secondary lens may be less than 3 mm, e.g. in the range from 0.01 mm to 2 mm, such as in the range from 0.05 mm to 0.5 mm. In one or more exemplary lens assemblies, the distance D_{1,1} is in the range from 0.06 mm to 0.12 mm, e.g. about 0.09 mm.

The second secondary lens may have a thickness in the range from 1 mm to 15 mm, such as in the range from 3 mm to 9 mm. The thickness t_{2,2} of the second secondary lens may be in the range from 5 mm to 7 mm, such as about 6 mm.

The lens assembly may comprise a third lens group. The third lens group comprises a third primary lens and/or a third secondary lens. The third lens group or at least the third primary lens may be arranged between the light redirecting member and the aperture stop. The aperture stop may be arranged between the second lens group and the third lens group.

The lens assembly may have an equidistant mapping from the object side to the image side.

Table 1 shows properties of exemplary lens assemblies L1, . . . , L5. It is to be noted that one or more properties, e.g. radii and/or K-value,for one exemplary lens assembly may be combined with one or more radii from another exemplary lens assembly. For example, radii for the first lens group of a lens assembly, e.g. L1, may be combined with radii for the second lens group of another lens assembly, e.g. L4.

TABLE 1
Properties of exemplary lens assemblies.

| | L1 | L2 | L3 | L4 | L5 |
|---|---|---|---|---|---|
| r_{1,1,1} (mm) | 49.59 | 49.70 | 23.99 | 58.3 | >20 |
| K_{1,1,1} | 0 | 0 | 0 | 0 | 0 |
| r_{1,1,2} (mm) | 73.81 | 67.35 | 35.73 | 70.1 | >1.2 * r_{1,1,1} |
| K_{1,1,2} | 0 | 0 | 0 | 0 | |
| t_{1,1} (mm) | 21.2 | 23 | 10.78 | 30.6 | 5 to 40 |
| r_{1,2,1} (mm) | 32 | 25 | 15.53 | 17.5 | 10 to 40 |
| K_{1,2,1} (mm) | −10 | −10.79 | 0 | −4.52 | −3 to −12 |
| r_{1,2,2} (mm) | 6.87 | 5.50 | 8.65 | 6.1 | 4 to 10 |
| K_{1,2,2} | −0.7 | −0.69 | 0 | −6.8 | 0 to −10 |
| t_{1,2} (mm) | 3 | 3 | 1 | 2.8 | 0.5 to 4 |
| D_{1,1} (mm) | 19.3 | 22 | 4.25 | 17.5 | 15 to 25 |
| r_{2,1,1} (mm) | −13.43 | 109 | −242.43 | 528 | −300 to 600 |
| K_{2,1,1} | 0 | 0 | 0 | 0 | 0 |
| r_{2,1,2} (mm) | −15.63 | −29.8 | 13.31 | −62.66 | <−10 or >10 |
| K_{2,1,2} | 0 | −9.75 | 0 | 0 | 0 |
| t_{2,1} (mm) | 1.31 | 3.69 | 1.1 | 2.54 | 0.5 to 5 |
| r_{2,2,1} (mm) | 24 | 29.56 | −19.79 | 21.07 | 15 to 35 or |
| | | | | | −25 to −15 |
| K_{2,2,1} | 0 | 0 | 0 | 0 | 0 |
| r_{2,2,2} (mm) | −42 | −60.73 | 136.49 | −13.69 | −70 to −10 |
| K_{2,2,2} | 0 | 0 | 0 | 0 | 0 |
| t_{2,2} (mm) | 6.02 | 8.99 | 1.1 | 3.89 | 0.5 to 10 |
| D_{2,1} (mm) | 0.09 | 0.1 | 6.25 | 0.2 | |

In the present disclosure, r_{1,1,1} denotes the radius (curvature) of the first surface of the first primary lens, r_{1,1,2} denotes the radius (curvature) of the second surface of the first primary lens, r_{1,2,1} denotes the radius (curvature) of the first surface of the first secondary lens, r_{1,2,2} denotes the radius (curvature) of the second surface of the first secondary lens, r_{2,1,1} denotes the radius (curvature) of the first surface of the second primary lens, r_{2,1,1} denotes the radius (curvature) of the second surface of the second primary lens, r_{2,2,1} denotes the radius (curvature) of the first surface of the second secondary lens, and r_{2,2,2} denotes the radius (curvature) of the second surface of the second secondary lens. Further, t_{1,1} denotes the thickness of the first primary lens, t_{1,2} denotes the thickness of the first secondary lens, t_{2,1} denotes the thickness of the second primary lens, t_{2,2} denotes the thickness of the second secondary lens, D_{1,1} denotes the distance between the first primary lens and the first secondary lens, and D_{2,1} denotes the distance between the second primary lens and the second secondary lens. K_{1,1,1} denotes the conic constant of the first surface of the first primary lens, K_{1,1,2} denotes the conic constant of the second surface of the first primary lens, K_{1,2,1} denotes the conic constant of the first surface of the first secondary lens, K_{1,2,2} denotes the conic constant of the second surface of the first secondary lens, K_{2,1,1} denotes the conic constant of the first surface of the second primary lens, K_{2,1,2} denotes the conic constant of the second surface of the second primary lens, K_{2,2,1} denotes the conic constant of the first surface of the second secondary lens, and K_{2,2,2} denotes the conic constant of the second surface of the second secondary lens.

The camera lens system comprises a first lens assembly and/or a second lens assembly. The first lens assembly may have a horizontal field of view larger than 90 degrees. The first lens assembly may have a horizontal field of view in the range from 90 to 96 degrees. The first lens assembly may have a horizontal field of view in the range from 60 to 65 degrees. The first lens assembly may have a vertical field of view of 8 degrees to 160 degrees, such as in the range from 40 to 96 degrees. The first lens assembly may have a vertical field of view in the range from 90 to 96 degrees. The first lens assembly may have a vertical field of view in the range from 60 to 66 degrees.

The second lens assembly may have a horizontal field of view larger than 90 degrees. The second lens assembly may have a horizontal field of view in the range from 90 to 96 degrees. The second lens assembly may have a horizontal field of view in the range from 60 to 66 degrees. The second lens assembly may have a vertical field of view of 8 degrees to 160 degrees, such as in the range from 40 to 96 degrees. The second lens assembly may have a vertical field of view in the range from 90 to 96 degrees. The second lens assembly may have a vertical field of view in the range from 60 to 66 degrees.

In one or more exemplary camera lens systems, the second optical path segment of the first lens assembly and the second optical path segment of the second lens assembly are parallel and point in the same direction.

In one or more exemplary camera lens systems, the first angle of one or more of the first primary lenses may be equal to or less than 90−[360/(2*N)] degrees where N is the number of horizontal lens assemblies in the camera lens system. For example, the first angle of one or more first primary lenses may be 45 degrees or in the range from 20 degrees to 45 degrees, e.g. for a camera lens system having four horizontal lens assemblies, e.g. each having a horizontal field of view in the range from 90 degrees to 96 degrees. For example, the first angle of one or more first primary lenses may be 60 degrees or in the range from 35 degrees to 60 degrees, e.g. for a camera lens system having six horizontal lens assemblies, e.g. each having a horizontal field of view in the range from 60 degrees to 66 degrees.

In one or more exemplary camera lens systems, the second angle and/or the third angle of one or more of the first primary lenses may be equal to or less than 90−[360/(2*N)] degrees where N is the number of horizontal lens assemblies in the camera lens system. For example, the second angle and/or a third angle of one or more first primary lenses may be 45 degrees or in the range from 20 degrees to 45 degrees for a camera lens system having four horizontal lens assemblies, e.g. each having a horizontal field of view in the range from 90 degrees to 96 degrees. For example, the second angle and/or the third angle of one or more first primary lenses may be 60 degrees or in the range from 35 degrees to 60 degrees, e.g. for a camera lens system having six horizontal lens assemblies, e.g. each having a horizontal field of view in the range from 60 degrees to 66 degrees.

In one or more exemplary camera lens systems, a side surface of one lens assembly faces and/or is parallel to a side surface of another lens assembly. For example, side surface S_{1,1} may face and/or be parallel to side surface S_{2,3,} i.e. N_{1,1} and N_{2,3} point in opposite directions. In one or more exemplary camera lens systems, the angle between side normals N_{1,1} and N_{2,3} is larger than 135 degrees, such as larger than 170 degrees.

In one or more exemplary camera lens systems, the angle between side normals N_{2,1} and N_{3,3} is larger than 135 degrees, such as larger than 170 degrees. In one or more exemplary camera lens systems, the angle between side normals N_{3,1} and N_{4,3} is larger than 135 degrees, such as larger than 170 degrees. In one or more exemplary camera lens systems, the angle between side normals N_{4,1} and N_{1,3} is larger than 135 degrees, such as larger than 170 degrees. In one or more exemplary camera lens systems, the angle between side normals N_{1,2} and N_{5,1} is larger than 135 degrees, such as larger than 170 degrees. In one or more exemplary camera lens systems, the angle between side normals N_{2,2} and N_{5,2} is larger than 135 degrees, such as larger than 170 degrees. In one or more exemplary camera lens systems, the angle between side normals N_{3,2} and N_{5,3} is larger than 135 degrees, such as larger than 170 degrees. In one or more exemplary camera lens systems, the angle between side normals N_{4,2} and N_{5,4} is larger than 135 degrees, such as larger than 170 degrees.

The camera lens system may comprise a frame or frame assembly supporting the different lenses in the camera lens system. The frame may comprise one or more walls, e.g. for optically separating at least parts of different lens assemblies. A frame with walls between first primary lenses of the lens assemblies enables a camera with reduced optical cross-over from one lens assembly to another. Further, a frame facilitates precise and accurate assembly of the camera system or the camera lens system.

The camera lens system may consist of two, three, four, five, six or seven lens assemblies. In one or more exemplary camera lens systems, the camera lens system comprises eight or more lens assemblies.

A distance between the first virtual position and the second virtual position may be less than 10 mm, such as less than 7 mm, preferably less than 3 mm. The first virtual position and the second virtual position may coincide or at least partly overlap.

The camera lens system may comprise a third lens assembly being a lens assembly as described herein. The camera lens system may comprise a fourth lens assembly being a lens assembly as described herein. The third lens assembly has a third entrance pupil with a third virtual position. The fourth lens assembly has a fourth entrance pupil with a fourth virtual position. A distance between the third virtual position and the fourth virtual position may be less than 10 mm, such as less than 7 mm, preferably less than 3 mm. The third virtual position and/or the fourth virtual position may coincide or at least partly overlap with the first virtual position. A distance between the third virtual position and the first virtual position may be less than 10 mm, such as less than 7 mm, preferably less than 3 mm. A distance between the fourth virtual position and the first virtual position may be less than 10 mm, such as less than 7 mm, preferably less than 3 mm.

In one or more exemplary camera lens systems, the second optical path segment of the first lens assembly and the second optical path segment of the third lens assembly are parallel and point in the same direction. In one or more exemplary camera lens systems, the second optical path segment of the first lens assembly and the second optical path segment of the fourth lens assembly are parallel and point in the same direction.

In one or more exemplary camera lens systems, the camera lens system comprises four lens assemblies as described herein, wherein each of the four lens assemblies may have a horizontal field of view larger than 90 degrees. Each of the four lens assemblies may have a horizontal field of view in the range from 90 degrees to 96 degrees, such as about 92 degrees. Each of the four lens assemblies may have a vertical field of view in the range from 90 degrees to 96 degrees, such as about 92 degrees. It may be desired to reduce the field of view overlap, e.g. to avoid redundant information and optimize the pixel angular density. The first optical axis of the first lens assembly and the first optical axis of the second lens assembly may form an angle in the range from 85 degrees to 95 degrees, such as 90 degrees. The first optical axis of the first lens assembly and the first optical axis of the third lens assembly may form an angle less than 5 degrees. The first optical axis of the first lens assembly and the first optical axis of the third lens assembly may be parallel. The first optical axis of the second lens assembly and the first optical axis of the fourth lens assembly may form an angle less than 5 degrees. The first optical axis of the second lens assembly and the first optical axis of the fourth lens assembly may be parallel.

The camera lens system may comprise a fifth lens assembly, the fifth lens assembly comprising a first lens group and an aperture stop, the first lens group having a first optical axis and comprising a first primary lens. The first optical axis of the first lens assembly and the first optical axis of the fifth lens assembly may form an angle in the range from 85 degrees to 95 degrees, such as 90 degrees. The fifth lens assembly may also be denoted a vertical lens assembly. The first optical axis of the second lens assembly and the first optical axis of the fifth lens assembly may form an angle in the range from 85 degrees to 95 degrees, such as 90 degrees. The first optical axis of the third lens assembly and the first optical axis of the fifth lens assembly may form an angle in the range from 85 degrees to 95 degrees, such as 90 degrees. The first optical axis of the fourth lens assembly and the first optical axis of the fifth lens assembly may form an angle in the range from 85 degrees to 95 degrees, such as 90 degrees.

In one or more exemplary camera lens systems, on or more side angles, such as the first angle, the second angle, the third angle and/or the fourth angle of the first primary lense of a vertical lens assembly may be equal to or less than 90−[360/(2*N)] degrees where N is the number of horizontal lens assemblies in the camera lens system. For example, the second angle and/or a third angle of one or more first primary lenses may be 45 degrees or in the range from 20 degrees to 45 degrees for a camera lens system having four horizontal lens assemblies, e.g. each having a horizontal field of view in the range from 90 degrees to 96 degrees.

The first optical axis of the first lens assembly and the first optical axis of the fifth lens assembly may form an angle in the range from 55 degrees to 65 degrees, such as 60 degrees. The first optical axis of the second lens assembly and the first optical axis of the fifth lens assembly may form an angle in the range from 55 degrees to 65 degrees, such as 60 degrees. The first optical axis of the third lens assembly and the first optical axis of the fifth lens assembly may form an angle in the range from 55 degrees to 65 degrees, such as 60 degrees. The first optical axis of the fourth lens assembly and the first optical axis of the fifth lens assembly may form an angle in the range from 55 degrees to 65 degrees, such as 60 degrees.

In one or more exemplary camera lens systems, a side surface of the first primary lens of a lens assembly is adjacent to and/or faces a side surface of the first primary lens of another lens assembly. For example, the first side surface of the first primary lens of the first lens assembly may be adjacent to and/or face a third side surface of the first primary lens of the second lens assembly. Additionally, or alternatively, the first side surface of the first primary lens of the second lens assembly may be adjacent to and/or face a third side surface of the first primary lens of the third lens assembly. Additionally, or alternatively, the first side surface of the first primary lens of the third lens assembly may be adjacent to and/or face a third side surface of the first primary lens of the fourth lens assembly. Additionally, or alternatively, the first side surface of the first primary lens of the fourth lens assembly may be adjacent to and/or face a third side surface of the first primary lens of the first lens assembly.

The second side surface of the first primary lens of the first lens assembly may be adjacent to and/or face a first side surface of the first primary lens of the fifth lens assembly. The second side surface of the first primary lens of the second lens assembly may be adjacent to and/or face a second side surface of the first primary lens of the fifth lens assembly. The second side surface of the first primary lens of the third lens assembly may be adjacent to and/or face a third side surface of the first primary lens of the fifth lens assembly. The second side surface of the first primary lens of the fourth lens assembly may be adjacent to and/or face a fourth side surface of the first primary lens of the fifth lens assembly.

The camera system may comprise a first detector assembly comprising a first image detector associated with the first lens assembly. The first image detector may be associated with the second lens assembly. The first image detector comprises a first detector area, wherein a first image plane of the first lens assembly is recorded by the first detector area through the first lens assembly. The first image detector may comprise further detector area(s), e.g. second detector area and/or third detector area. wherein further image plane(s) of further lens assembly/assemblies. e.g. second lens assembly and/or third lens assembly, is recorded by the further detector area(s) through the further lens assembly/assemblies. Thus, the first image detector may record image planes of two, three or more lens assemblies with respective two, three or more detector areas.

The camera system may comprise a second detector assembly comprising a second image detector associated with the second lens assembly. The second image detector comprises a second detector area, wherein a second image plane of the second lens assembly is optionally recorded by the second detector area through the second lens assembly.

In the camera system, at least a first detector area normal of the first detector area and a second detector area normal of the second detector area may point in the same direction or at least form an angle less than 15 degrees. The first detector area and the second detector area may be parallel and face the same direction

The camera system may comprise a separate image detector/detector assembly for each lens assembly. The first image detector and the second image detector may lie in the same plane, i.e. image detector areas may be aligned along the central axis of the camera system. The camera system may comprise a third detector assembly comprising a third image detector. The third image detector may have a third detector area, wherein an image plane of the third lens assembly is recorded by the third detector area. The camera system may comprise a fourth detector assembly comprising a fourth image detector. The fourth image detector may have a fourth detector area, wherein an image plane of the fourth lens assembly is recorded by the fourth detector area.

An image detector or a detector area of an image detector may comprise at least 4 k pixels, e.g. arranged in an array with M×N pixels. M may be at least 2,048 and/or N may be at least 2,048. The camera system may have a pixel angular density (pixels per degree of field of view) larger than 10. In one or more exemplary camera systems, the pixel angular density (pixels per degree of field of view) is larger than 20 or at least 50. In one or more exemplary camera systems, e.g. for camera lens systems having lens assemblies with FOV's less than 30 degrees, such as less than 10 degrees or in the range from 10 to 30 degrees, the pixel angular density (pixels per degree of field of view) may be larger than 100, about 200, 300, 400, 500, 600, 700, 800, 900 or even 1,000 or more.

In one or more exemplary camera lens systems, the second optical path segment of the first lens assembly and the second optical path segment of the second lens assembly are parallel and/or form an angle less than 5 degrees. In one or more exemplary camera lens systems, the second optical path segment of the first lens assembly and the second optical path segment of the third lens assembly are parallel and/or form an angle less than 5 degrees. In one or more exemplary camera lens systems, the second optical path segment of the first lens assembly and the second optical path segment of the fourth lens assembly are parallel and/or form an angle less than 5 degrees. Second optical path segments of the first lens assembly and the second lens assembly may point in the same direction, i.e. detector areas of the image detector(s) face the same direction. Second optical path segments of the first lens assembly and the third lens assembly may point in the same direction, i.e. detector areas of the image detector(s) face the same direction. Second optical path segments of the first lens assembly and the fourth lens assembly may point in the same direction, i.e. detector areas of the image detector(s) face the same direction. Thus the use of a single image detector for two or more lens assemblies may be provided for.

In one or more exemplary camera lens systems, the second optical path segment of the first lens assembly and the first optical axis of the fifth lens assembly are parallel and/or form an angle less than 5 degrees.

The camera lens system may have a horizontal field of view of 360 degrees. The camera lens system may have a vertical field of view larger than 180 degrees, such as at least 270 degrees.

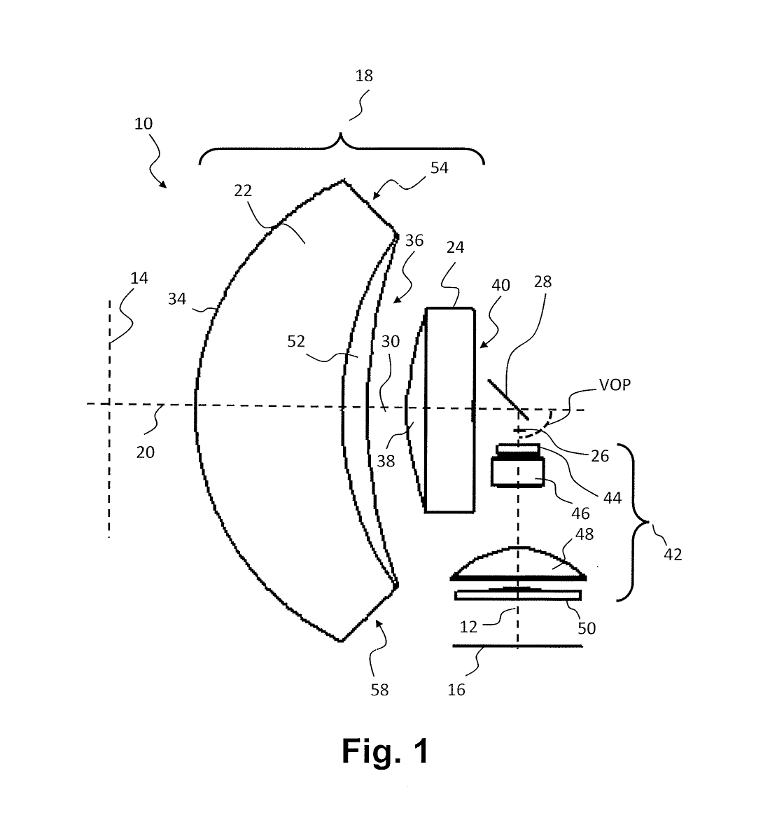

FIG. 1 schematically illustrates an exemplary lens assembly for a camera. The lens assembly 10 has an optical path 12 from an object side 14 to an image side 16. The lens assembly 10 comprises a first lens group 18 having a first optical axis 20. The first lens group 18 comprises a first primary lens 22 and a first secondary lens 24. Further, the lens assembly 10 comprises an aperture stop 26 and a light redirecting member 28. The light redirecting member 28 is arranged between the first lens group 18 and the aperture stop 26, such that the optical path 12 comprises a first optical path segment 30 and a second optical path segment 32. The first optical path segment 30 and the second optical path segment 32 form an angle VOP larger than 30 degrees, namely 90 degrees.

The lens assembly 10 has a vertical field of view in the range from 45 degrees to 135 degrees, namely about 92 degrees. The lens assembly 10 has a horizontal field of view in the range from 45 degrees to 135 degrees, namely about 92 degrees.

The first primary lens 22 has a convex and spherical first surface 34 and a concave and spherical second surface 36. The first surface radius r_{1,1,1} of the first primary lens 22 is in the range from may be in the range from 30 mm to 70 mm, such as in the range from 40 mm to 60 mm. In lens assembly 10, the first surface radius r_{1,1,1} of the first primary lens 22 is about 50 mm (49.59 mm). The second surface radius r_{1,1,2} of the first primary lens is larger than the first surface radius r_{1,1,1} and being in the range from 50 mm to 100 mm. such as in the range from 65 mm to 85 mm. In lens assembly 10, the second surface radius r_{1,1,2} of the first primary lens 22 is about 74 mm (73.82 mm).

The first primary lens 22 has a first side surface 52, a second side surface 54, a third side surface 56, and optionally a fourth side surface 58. The side surfaces 52, 54. 56, 58 are plane surfaces with respective first side normal, second side normal, third side normal, and fourth side normal.

The first secondary lens 24 has a conical/parabolic first surface 38 and a conical/parabolic second surface 40.

The lens assembly 10 comprises a second lens group 42 comprising a second primary lens 44, wherein the aperture stop 26 is arranged between the light redirecting member 28 and the second primary lens 44. In other words, the second primary lens 44 is arranged after the aperture stop 26 when the optical path is followed from the object side 14 to the image side 16 of the lens assembly.

The second lens group 42 comprises a second secondary lens 46 arranged after the second primary lens 44, i.e. between the second primary lens and the image side 16.

The second lens group 42 optionally comprises a second tertiary lens 48 arranged after the second secondary lens 46.

The second lens group 42 optionally comprises a second quaternary lens 50 arranged after the second tertiary lens 48.

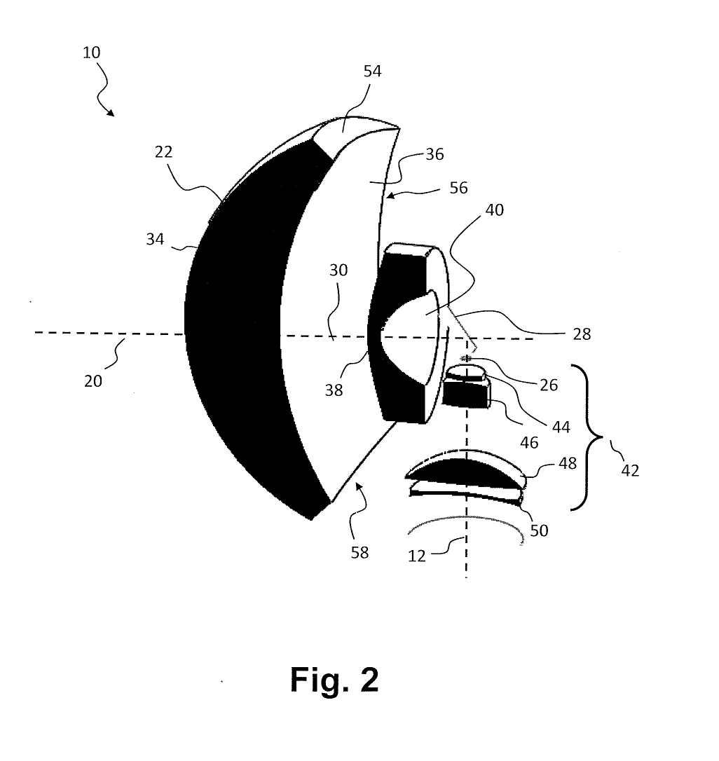

FIG. 2 shows a perspective view of a cross-section of lens assembly 10. The aperture stop 26 has an aperture with a diameter in the range from 0.5 mm to 5 mm, such as 1.56 mm.

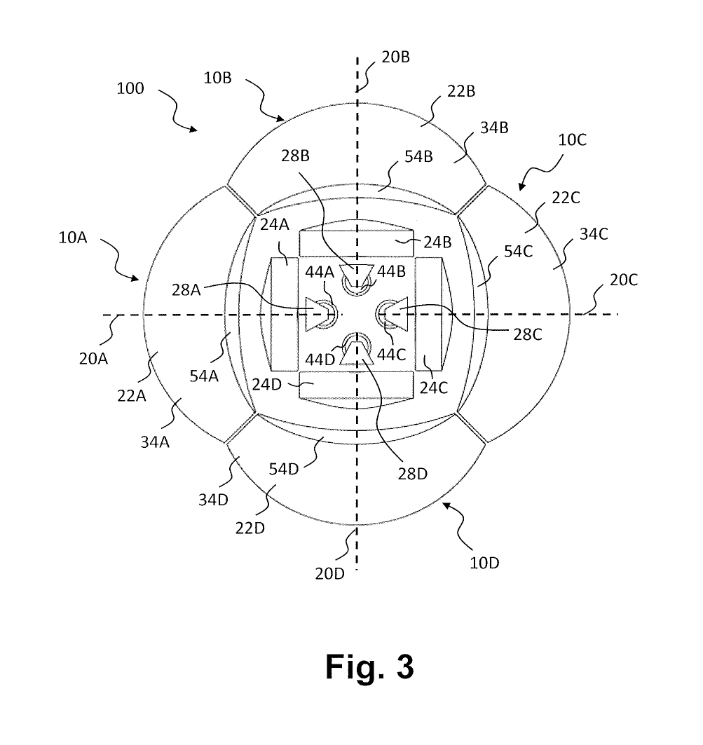

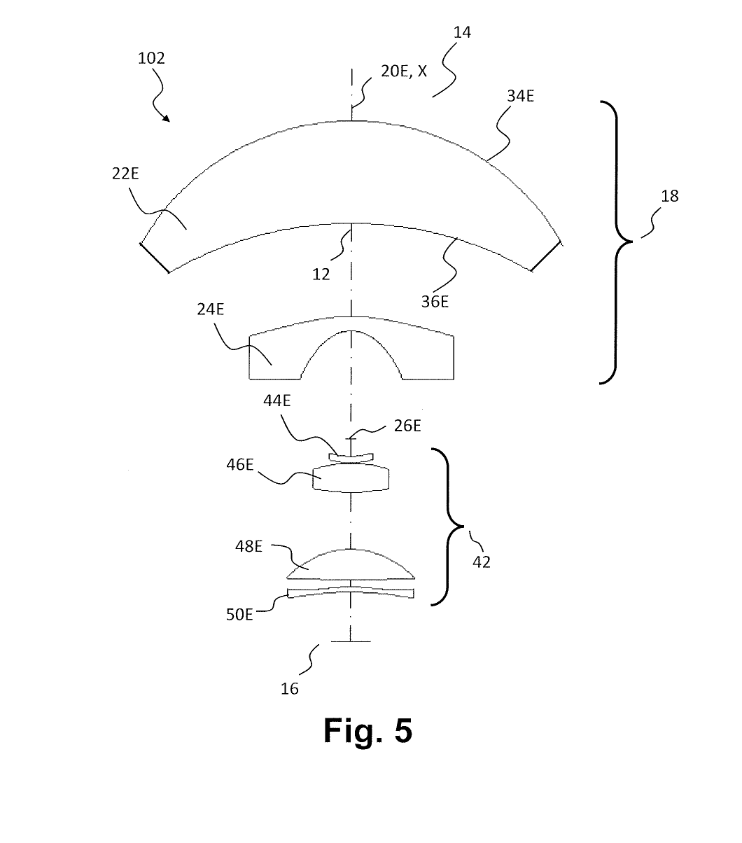

FIG. 3 shows a top view of an exemplary camera lens system. The camera lens system 100 comprises a first lens assembly 10A, a second lens assembly 10B, a third lens assembly 10C, and a fourth lens assembly 10D. Each lens assembly 10A, 10B, 10C, 10D is in the form of lens assembly 10. The camera lens system has a central axis X (see also FIG. 5). and lens assemblies 10A. 10B, 10C, IOD are arranged with respective first optical axes 20A. 20B, 20C 20D perpendicular to the central axis X. Further, lens assemblies 10A, 10B, IOC. 10D are arranged, such that first optical axes 20A and 20B are perpendicular, first optical axes 20A and 20C are parallel, first optical axes 20B and 20D are parallel, and first optical axes 20A and 20D are perpendicular. The first side surface of the first primary lens 22A faces the third side surface of the first primary lens 22B and the first side surface of the first primary lens 22B faces the third side surface of the first primary lens 22C. The first side surface of the first primary lens 22C faces the third side surface of the first primary lens 22D and the first side surface of the first primary lens 22D faces the third side surface of the first primary lens 22A.

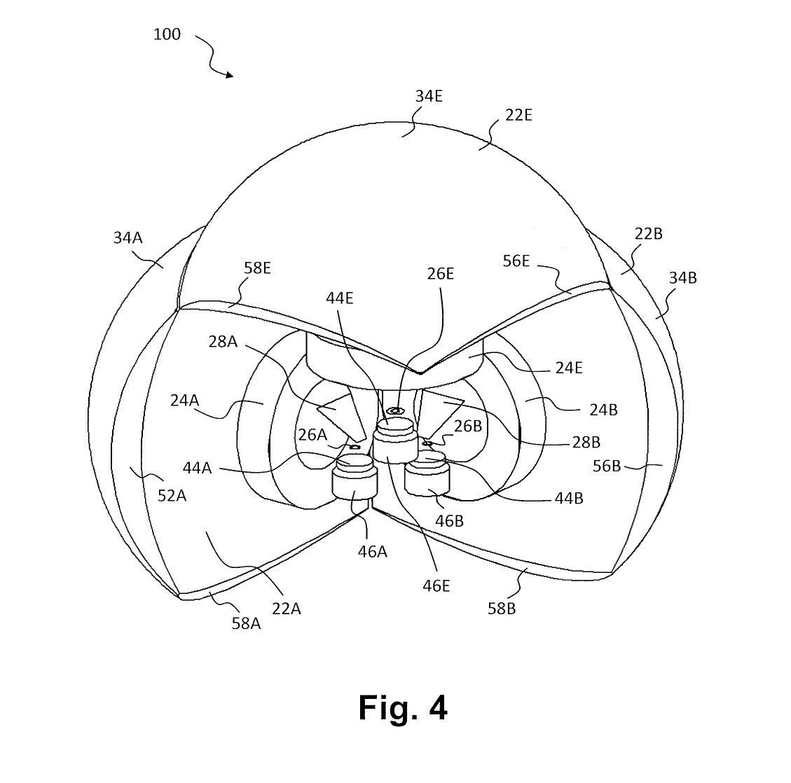

The camera lens system 100 comprises a fifth lens assembly, which is not shown for illustrative purposes, however, see FIG. 4.

FIG. 4 shows a cutaway perspective view of the camera lens system 100. The camera system 100 comprises a fifth lens assembly comprising a first lens group having a first optical axis parallel and coinciding with the central axis of the camera lens system. The first lens group comprises first primary lens 22E and first secondary lens 24E. The fifth lens assembly comprises aperture stop 26E arranged after the first lens group 22E, 24E. A second lens group comprising second primary lens 44E and second secondary lens 46E is arranged after the aperture stop 26E

FIG. 5 schematically illustrates an exemplary fifth lens assembly for a camera lens system, e.g. the camera lens system 100. The fifth lens assembly 102 has an optical path 12 from an object side 14 to an image side 16. The fifth lens assembly 102 comprises a first lens group 18 having a first optical axis 20E. The first lens group 18 comprises a first primary lens 22E and a first secondary lens 24E. Further, the fifth lens assembly 102 comprises an aperture stop 26E after the first lens group.

The fifth lens assembly 102 has a vertical field of view in the range from 45 degrees to 135 degrees, namely about 92 degrees. The fifth lens assembly 102 has a horizontal field of view in the range from 45 degrees to 135 degrees, namely about 92 degrees.

The first primary lens 22E has a convex and spherical first surface 34E and a concave and spherical second surface 36E and corresponds to the first primary lens 22 described in relation to FIG. 1.

The first secondary lens 24E corresponds to the first secondary lens 24 described in relation to FIG. 1.

The fifth lens assembly 102 comprises a second lens group 42 arranged after the aperture stop 26E when the optical path is followed from the object side 14 to the image side 16 of the fifth lens assembly 102. The second lens group 42 of the fifth lens assembly correspond to the second lens group of lens assembly 10 described in relation to FIG. 1.

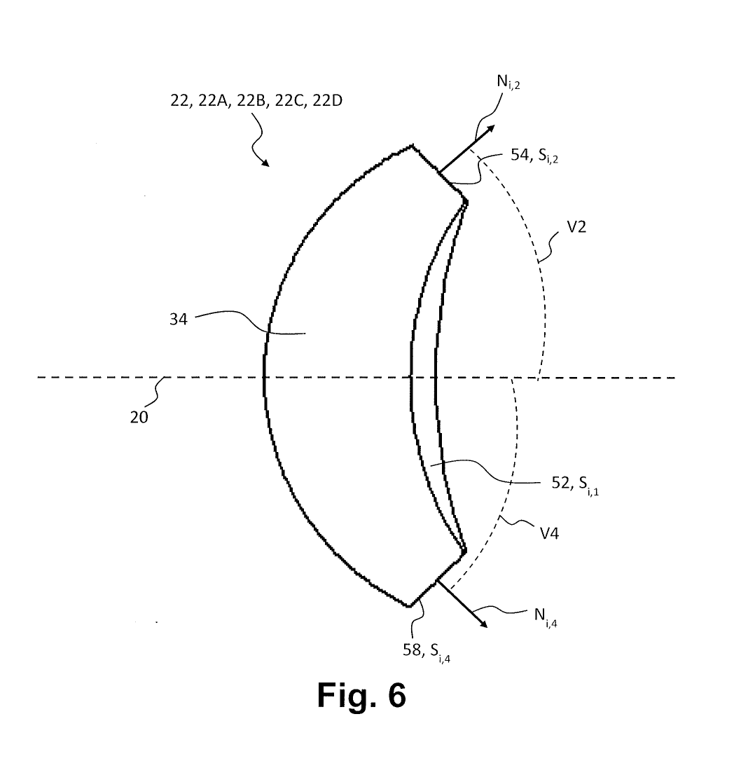

FIG. 6 shows a side view of an exemplary first primary lens. The first primary lens 22 comprises a first side surface 52, S_{1,1} having a first side normal N_{1,1}, a second side surface 54, S_{i,2} having a second side normal N_{i,2}, a third side surface S_{i,3} having a third side normal N_{i,3} (not visible) and optionally a fourth side surface 58, S_{i,4} having a fourth side normal N_{i,4}, where i is an index of the I'th lens assembly. The angles between a side normal N._{i,1}, N_{i,2}, N_{i,3}, N_{i,4} and the optical axis 20 are respectively denoted V1, V2, V3 and V4 and are each in the range from 40 degrees to 45 degrees. The side surfaces 52, 54, 56, 58 of the first primary lens 22 are coated with a non-reflective and non-transmissive coating.

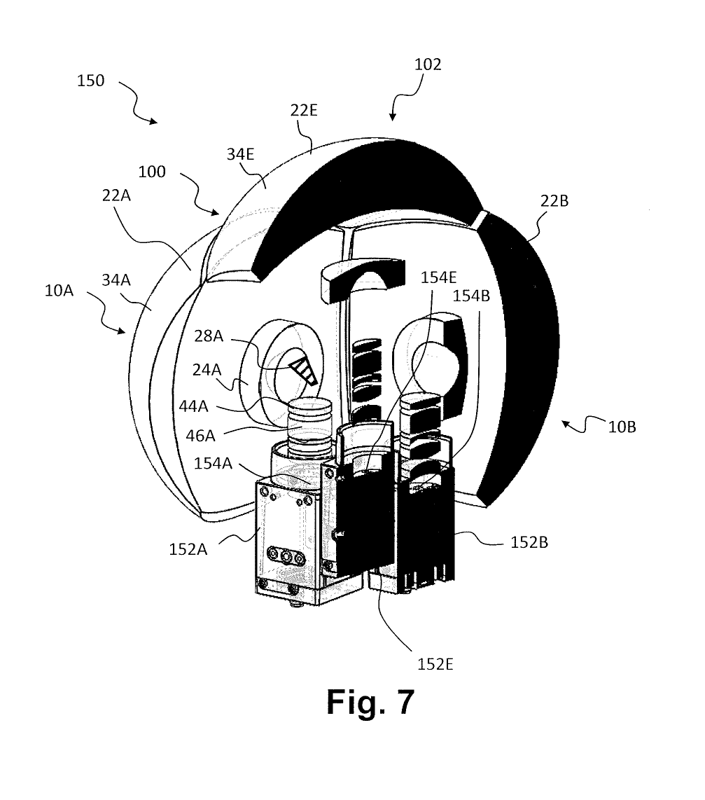

FIG. 7 shows a perspective cut-away view of a camera system according to the invention. The camera system 150 comprises a camera lens system 100 with first lens assembly 10A, second lens assembly 10B, third lens assembly 10C (not shown), fourth lens assembly 10D (not shown), and fifth lens assembly 102. Further, the camera system 150 comprises a first detector assembly 152A comprising a first image detector 154A associated with the first lens assembly 10A. The first image detector comprises a first detector area, wherein a first image plane of the first lens assembly is recorded by the first detector area through the first lens assembly 10A.

The camera system 150 comprises a second detector assembly 152B comprising a second image detector 154A associated with the second lens assembly 10B. The second image detector comprises a second detector area, wherein a second image plane of the second lens assembly is recorded by the second detector area through the second lens assembly 10B.

The camera system 150 comprises a third detector assembly (not shown) comprising a third image detector (not shown) associated with the third lens assembly (not shown). The third image detector comprises a third detector area, wherein a third image plane of the third lens assembly is recorded by the third detector area through the third lens assembly.

The camera system 150 comprises a fourth detector assembly (not shown) comprising a fourth image detector (not shown) associated with the fourth lens assembly (not shown). The fourth image detector comprises a fourth detector area, wherein a fourth image plane of the fourth lens assembly is recorded by the fourth detector area through the fourth lens assembly.

The camera system 150 comprises a fifth detector assembly 152E comprising a fifth image detector 154E associated with the fifth lens assembly 102. The fifth image detector comprises a fifth detector area. wherein a fifth image plane of the fifth lens assembly is recorded by the fifth detector area through the fifth lens assembly 10E.

In one or more exemplary camera systems. the image detectors may be mounted as a part of the same detector assembly. e.g. on a single substrate or printed circuit board.

In the illustrated camera system 150, at least the first image detector 152A and the second image detector 152B are arranged in the same plane. At least a first detector area normal of the first detector area and a second detector area normal of the second detector area may point in the same direction or at least form an angle less than 15 degrees. In the illustrated camera system 150, a first detector area normal of the first detector area, a second detector area normal of the second detector area, a third detector area normal of the third detector area, a fourth detector area normal of the fourth detector area, and a fifth detector area normal of the fifth detector area point in the same direction or at least form a maximum angle less than 15 degrees between respective detector area normals.

### LIST OF REFERENCES

10 lens assembly

10A first lens assembly

10B second lens assembly

10C third lens assembly

10D fourth lens assembly

12 optical path

14 object side

16 image side

18 first lens group

20 first optical axis

20A first optical axis of first lens group of first lens assembly

20B first optical axis of first lens group of second lens assembly

20C first optical axis of first lens group of third lens assembly

20D first optical axis of first lens group of fourth lens assembly

20E first optical axis of first lens group of fifth lens assembly

22 first primary lens

22A first primary lens of first lens assembly

22B first primary lens of second lens assembly

22C first primary lens of third lens assembly

22D first primary lens of fourth lens assembly

22E first primary lens of fifth lens assembly

24 first secondary lens

24A first secondary lens of first lens assembly

24B first secondary lens of second lens assembly

24C first secondary lens of third lens assembly

24D first secondary lens of fourth lens assembly

24E first secondary lens of fifth lens assembly

26 aperture stop

26A aperture stop of first lens assembly

26B aperture stop of second lens assembly

26E aperture stop of fifth lens assembly

28 light redirecting member

28A light redirecting member of first lens assembly

28B light redirecting member of second lens assembly

28C light redirecting member of third lens assembly

28D light redirecting member of fourth lens assembly

30 first optical path segment

32 second optical path segment

34 first surface of first primary lens

34A first surface of first primary lens of first lens assembly

34B first surface of first primary lens of second lens assembly

34C first surface of first primary lens of third lens assembly

34D first surface of first primary lens of fourth lens assembly

34E first surface of first primary lens of fifth lens assembly

36 second surface of first primary lens

36A second surface of first primary lens of first lens assembly

36B second surface of first primary lens of second lens assembly

36C second surface of first primary lens of third lens assembly

36D second surface of first primary lens of fourth lens assembly

36E second surface of first primary lens of fifth lens assembly

38 first surface of first secondary lens

40 second surface of first secondary lens

42 second lens group

44 second primary lens

44A second primary lens of first lens assembly

44B second primary lens of second lens assembly

44C second primary lens of third lens assembly

44D second primary lens of fourth lens assembly

46 second secondary lens

46A second secondary lens of first lens assembly

46B second secondary lens of second lens assembly

46E second secondary lens of fifth lens assembly

48 second tertiary lens

50 second quaternary lens

52 first side surface of first primary lens

52A first side surface of first primary lens of first lens assembly

52B first side surface of first primary lens of second lens assembly

52C first side surface of first primary lens of third lens assembly

52D first side surface of first primary lens of fourth lens assembly

52E first side surface of first primary lens of fifth lens assembly

54 second side surface of first primary lens

54A second side surface of first primary lens of first lens assembly

54B second side surface of first primary lens of second lens assembly

54C second side surface of first primary lens of third lens assembly

54D second side surface of first primary lens of fourth lens assembly

54E second side surface of first primary lens of fifth lens assembly

56 third side surface of first primary lens

56A third side surface of first primary lens of first lens assembly

56B third side surface of first primary lens of second lens assembly

56C third side surface of first primary lens of third lens assembly

56D third side surface of first primary lens of fourth lens assembly

56E third side surface of first primary lens of fifth lens assembly

58 fourth side surface of first primary lens

58A fourth side surface of first primary lens of first lens assembly

58B fourth side surface of first primary lens of second lens assembly

58C fourth side surface of first primary lens of third lens assembly

58D fourth side surface of first primary lens of fourth lens assembly

58E fourth side surface of first primary lens of fifth lens assembly

100 camera lens system

102 fifth lens assembly

150 camera system

152A first detector assembly

152B second detector assembly

152E fifth detector assembly

154A first image detector

154B second image detector

154E fifth image detector

X central axis

VOP angle between first optical path segment and second optical path segment

r_{1,1,1} radius of the first surface of the first primary lens

r_{1,1,2} radius of the second surface of the first primary lens

r_{1,2,1} radius of the first surface of the first secondary lens

r_{1,2,2} radius of the second surface of the first secondary lens

r_{2,1,1} radius of the first surface of the second primary lens

r_{2,1,2} radius of the second surface of the second primary lens

r_{2,2,1} radius of the first surface of the second secondary lens

r_{2,2,2} radius of the second surface of the second secondary lens

V1 first angle between first side normal and first optical axis

V2 second angle between second side normal and first optical axis

V3 third angle between third side normal and first optical axis

V4 fourth angle between fourth side normal and first optical axis

1. A lens assembly for a camera, the lens assembly having an optical path from an object side to an image side, the lens assembly comprising
a first lens group having a first optical axis and including a first primary lens;
an aperture stop; and
a light redirecting member,
wherein the light redirecting member is between the first lens group and the aperture stop such that the optical path includes a first optical path segment and a second optical path segment, wherein the first optical path segment and the second optical path segment form an angle larger than 30 degrees, and the lens assembly having a horizontal field of view in the range from 5 degrees to 135 degrees.

2. Lens assembly according to claim 1, wherein the first primary lens includes a first side surface having a first side normal forming an angle with the first optical axis, wherein the angle is in the range from 10 degrees to 90 degrees.

3. Lens assembly according to claim 1, further comprising a second lens group, the second lens group including a second primary lens, wherein the aperture stop is between the light redirecting member and the second primary lens.

4. Lens assembly according to claim 3, further comprising a third lens group, the third lens group including a third primary lens arranged between the light redirecting member and the aperture stop.

5. Lens assembly claim 1, wherein the first primary lens has a first surface and a second surface, wherein the first surface is convex and/or the second surface is concave.

6. Lens assembly according to claim 5, wherein the first surface of the first primary lens is spherical and having a first surface radius and/or the second surface of the first primary lens is spherical and having a second surface radius.

7. Lens assembly claim 1, the first lens group including a first secondary lens between the first primary lens and the light redirecting member.

8. Lens assembly according to claim 1, wherein the lens assembly has an equidistant mapping from the object side to the image side.

9. Camera lens system, comprising:
a first lens assembly including
a first lens group having a first optical axis and a first primary lens;
a first aperture stop; and
a first light redirecting member,
wherein the first light redirecting member is between the first lens group and the first aperture stop such that a first optical path includes a first optical path segment and a second optical path segment, wherein the first optical path segment and the second optical path segment form an angle larger than 30 degrees, and the first lens assembly having a horizontal field of view in the range from 5 degrees to 135 degrees; and
a second lens assembly, assembly including
a second lens group having a second optical axis and a second primary lens;
a second aperture stop; and
a second light redirecting member,
wherein the second light redirecting member is between the second lens group and the second aperture stop such that a second optical path includes a third optical path segment and a fourth optical path segment, wherein the third optical path segment and the fourth optical path segment form an angle larger than 30 degrees, and the second lens assembly having a horizontal field of view in the range from 5 degrees to 135 degrees,
wherein the first lens assembly has a first entrance pupil with a first virtual position along the first optical axis, and the second lens assembly has a second entrance pupil with a second virtual position along the first optical axis, wherein the first lens assembly and the second lens assembly are arranged such that a distance between the first virtual position and the second virtual position is less than 10 mm.

10. Camera lens system according to claim 9, wherein the lens assembly includes a third lens assembly and a fourth lens assembly, wherein the third lens assembly is a lens assembly has a third entrance pupil with a third virtual position along the first optical axis, and the fourth lens assembly is a lens assembly has having a fourth entrance pupil with a fourth virtual position along the first optical axis, and wherein the lens assemblies each has a horizontal field of view in the range from 90 degrees to 96 degrees.

11. Camera lens system according to claim 10, wherein the third lens assembly and the fourth lens assembly are arranged such that a distance between the third virtual position and the fourth virtual position is less than 10 mm.

12. Camera lens system according to claim 10, wherein the lens system includes a fifth lens assembly, the fifth lens assembly including a fifth lens group and a fifth aperture stop, the fifth lens group having a fifth optical axis and including a fifth primary lens, and wherein the first optical axis of the first lens assembly and the fifth optical axis of the fifth lens assembly form an angle of 90 degrees.

13. Camera system including a camera lens system according to claim 9, the camera system including a first image detector having a first detector area and a second detector area, wherein a first image plane of the first lens assembly is recorded by the first detector area and a second image plane of the second lens assembly is recorded by the second detector area.
